(19) United States
(12) Patent Application Publication
(10) Pub. No.: US 2005/0060202 A1
(43) Pub. Date: Mar. 17, 2005

(54) System and method for coupling a plurality of medical devices in serverless grid

(76) Inventors: Richard Taylor, Erie, CO (US); Todd Boris Jacobs, Fort Collins, CO (US); Chandra Dee Hays, Lafayette, CO (US)

Correspondence Address: MERCHANT & GOULD PC, P.O. BOX 2903, MINNEAPOLIS, MN, 55402-0903, US

(21) Appl. No.: 10/946,017

(22) Filed: Sep. 20, 2004

Related U.S. Application Data
(63) Continuation-in-part of application No. 10/453,422, filed on Jun. 2, 2003, now Pat. No. 6,803,054.
(60) Provisional application No. 60/384,902, filed on May 31, 2002.

(51) Int. Cl. G06F 17/60; G06F 15/16

(52) U.S. Cl. 705/2; 709/203

(57) ABSTRACT

The present invention presents a “serverless” medical information system network and method of creating one or more self-assembling and self-monitoring medical device network grids. Several communication node devices form each grid. Each node device may connect to one or more medical instruments, providing the medical instruments access to the network. The invention also includes methods for assembling the tree-like structure of the grid and balancing the load or placement of the nodes across the entire grid and for self-monitoring of the grid, such that the nodes can detect, record, and distribute changes to the status of any node in the grid. In addition, the nodes can provide web services to other computer devices, such as handheld devices.

### CROSS REFERENCES TO RELATED APPLICATION

The present application is a continuation in part of U.S. patent application Ser. No. 10/453,422, entitled COLLABORATION AMONG MEDICAL INSTRUMENTS (Attorney Docket No. 50611-292864), filed on Jun. 2, 2003, which is hereby incorporated by reference in its entirety, and which claims the benefit of priority from U.S. Provisional Application No. 60/384,902, filed May 31, 2002, which are hereby also incorporated by reference in its entirety.

### TECHNICAL FIELD

The present invention relates generally to the field of medical information systems. More particularly, the invention relates to systems for connecting medical devices into a network and for managing the medical devices and communicating medical information throughout the medical information system network.

### BACKGROUND OF THE INVENTION

To provide good and timely care to a sickly person, caregivers, such as doctors and medical professionals, rely on medical information. Much of the medical information available to doctors comes from medical instruments and devices. These instruments may range from Electrocardiogram (ECG) machines for monitoring a patient's heart function to simple infusion pumps for introducing liquids into a patient. As the medical devices have become more advanced, the devices have gained the capability to provide information electronically.

Many hospitals and medical care facilities have constructed networks to provide access to the data produced by the medical devices. These networks have used a common structure. Medical devices connected to the network form clients, while a server manages the network and controls the communications between the clients. This client/server environment is a hub-and-spoke type architecture. The server is the hub and the medical devices, computers, Personal Digital Assistants (PDAs), and other systems attached to the network are the spokes. All connections to the network must go through the server. The server monitors and controls all communications on the network. In essence, everything happening on the network involves the server.

Unfortunately, this architecture has downsides. The server often becomes a bottleneck. The abilities and resources of the server restrict the rapid and smooth communication of information through the network. In addition, clients connecting to the network have to go through the server, and if the server is busy, those client connections either wait or never occur.

The problems with the hub and spoke architecture are compounded particularly in a medical facility environment. Many medical devices used with patients are portable. Thus, a medical device coupled to the network frequently need to be moved around the hospital. The server has to manage the numerous changes to the configuration of the network caused by the roaming medical devices. The changes due to roaming medical devices increase the load on the server and enlarge the amount of communications over the network. As a result, the network is often slow, inefficient, and ineffective.

What is needed is a system for creating a network for medical systems that can be quickly created and efficiently managed. It is with respect to these considerations and others that the present invention has been made.

### SUMMARY OF THE INVENTION

The above and other problems are solved by a “serverless” medical information system network and method of creating one or more self-assembling and self-monitoring medical device grids. Several communication node devices form each grid. Each node device may connect to one or more medical instruments, providing the medical instruments access to the network.

The communication node devices assemble themselves into a tree-like architecture, where one node may have several children nodes. Embodiments of the invention include methods for assembling the tree-like structure and balancing the load or placement of the nodes across the entire grid. In addition, embodiments of the present invention provides methods for the nodes to self-monitor the grid, such that the nodes can detect, record, and distribute changes to the status of any node in the grid.

Each node provides a communication access point for the medical instruments located near the node. In addition, the nodes provide web services to other computer devices, such as handheld devices. For instance, a caregiver can access information from medical devices by connecting with a local node without accessing a server. Thus, the interaction with information requesters is a locally provided and server independent event.

These and other benefits of the present invention will be apparent to one skilled in the art after review of the attached claims, description, and accompanying drawings.

### BRIEF DESCRIPTION OF THE DRAWINGS

FIG. 1 illustrates an embodiment of a medical information system network including a plurality of grid segments according to the present invention.

FIG. 2 illustrates an embodiment of a computing device capable of functioning as a communication device node according to the present invention.

FIG. 3 illustrates an embodiment of a grid segment according to the present invention.

FIG. 4 illustrates a modular embodiment of the communication device node related to FIG. 2 according to the present invention.

FIG. 5 is a flowchart illustrating an embodiment of a method for connecting an unconnected node into an existing grid according to the present invention.

FIG. 6 is a flowchart illustrating an embodiment of a method for providing medical information from a communication device node according to the present invention.

FIG. 6A is a flowchart illustrating another embodiment of a method for providing medical information from a communication device node according to the present invention.

FIG. 7 is a flowchart illustrating an embodiment of a method for monitoring a grid by a node according to the present invention.

FIG. 8 is a flowchart illustrating an embodiment of a method for allowing a user to change the status of a grid according to the present invention.

In the drawings presented, like reference numerals refer to the same elements throughout the drawings.

### DETAILED DESCRIPTION OF THE INVENTION

The present invention will now be described more fully hereinafter with reference to the accompanying drawings, in which embodiments of the invention are shown. This invention may however, be embodied in many different forms and should not be construed as limited to the embodiments set forth herein. Rather, these illustrations or exemplary embodiments are provided so that this disclosure will be thorough and complete and will fully convey the scope of the invention to those skilled in the art.

In general, the present invention relates to a medical information system network composed of one or more serverless grid segments. Communication node devices create the grid segments. Each grid segment is an independent network capable of self-assembly and self-monitoring. The nodes provide local communication and computing services to local medical devices and local information requesters. Every node can provide network access to one or more medical devices.

Before describing the various embodiments of the present invention, some terms that will be used throughout this description are defined as follows.

A “communication node device” is a computing device that can assemble itself, with other communication node devices, into a grid segment. The communication node device, also referred to as “a node”, “an unconnected node”, or “a connected node”, is any hardware, software, or other device that can form a part of a grid segment and/or provide access to the network to one or more medical devices. In some embodiments, the node may also provide web services to local computing devices.

A “medical device” refers to any piece of equipment that may be used in the care of a patient. Medical devices may include, but are not limited to, infusion pumps, cardiac monitors, pulse oximeters, blood pressure monitors, ECG machines, or the like.

The terms “connected” or “coupled” and related terms refer to any type of physical, electrical, or communicative connection. These terms are not meant to be limiting but encompass any type of connection that allows the interaction of devices.

The term “serverless” refers to the absence of a central server in the network through which networks communications flow or which controls the network. In other words, no computing device within the network functions as a server that controls and manages the network. Rather, two or more communication node devices share or concurrently perform server-like duties of network management, network assembly and attachment, and network monitoring. However, the nodes within a grid may communicate with a server that is not controlling the grids but attached to the network. An example of this type of connected server would be a Hospital Information System (HIS) server described below.

A “grid management software” or “GridView™ Program” is a software application that provides an interface to a network administrator or other user of the grid of interconnected nodes. The software application can provide gird context data to the user in an understandable format. In addition, the software application can provide an interface for the user to make changes or updates to the configuration or status of the grid.

The term “grid context data” refers to a file or set of data that describes the configuration and/or status of a grid segment. Each node within a grid can store the grid context data.

The term “grid” or “grid segment” refers to a network or network portion formed by the interrelation of a plurality of nodes. The grid can form a tree-type architecture where nodes can comprise the branches of the “tree”. The branches may include nodes in parent/child relationships.

The term “web services” and the related term “web server” refer to the provision of an interface to an internet, such as the World Wide Web. These services are provided to the users of external computing devices that connect with a node through the web server. Generally, the web services include an interaction that communicates information through one or more web pages.

In accordance with embodiments of the present invention, the methods described herein may be executed as a set of computer instructions read and performed on a computer system. The invention may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

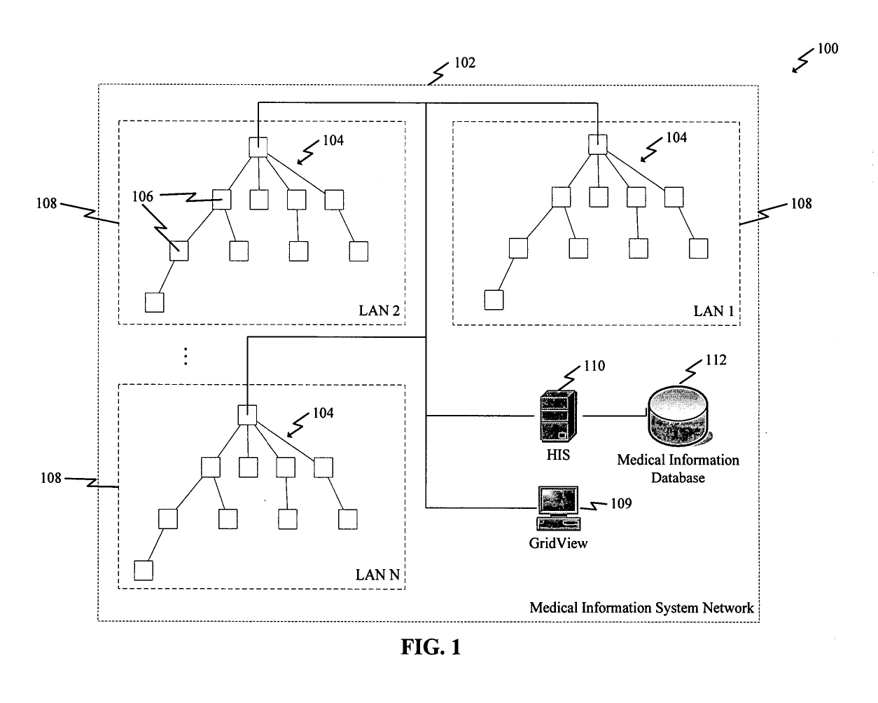

FIG. 1 shows a high-level block diagram of the suitable operating environment 100 according to one embodiment of the present invention. The suitable operating environment 100 is only one example of a suitable operating environment and is not intended to suggest any limitation as to the scope of use or functionality of the invention. Other well known computing systems, environments, and/or configurations that may be included for use with or added to the invention include, but are not limited to, personal computers, non-controlling servers, hand-held or laptop computer devices, multiprocessor systems, microprocessor-based systems, programmable consumer electronics, network PCs, minicomputers, mainframe computers, distributed computing environments that include any of the above systems or devices, and the like.

The suitable operating environment 100 includes a medical information system network 102. The network 102 does not include a server that controls, monitors, or creates the network 102. Rather, one or more grids 104, also referred to as grid segments 104, form the network 102. Each grid 104 is an independent operating environment. Monitoring, assembly, and control of the grid 104 occur within the grids 104.

The grids 104 may form separate Local Area Networks (LANs) 108 within a hospital or other patient care facility. A single physical network 102 may comprise an unlimited number of LANs 108 formed from an unlimited number of grids 104. The network 102 may connect each LAN 108 or grid 104, but the grids 104 can operate separately. Each LAN 108 or grid 104 may operate within a wing, ward, or section of the patient care facility. For instance, one gird 104 may form a LAN 108 within the emergency unit of a hospital while a separate grid 104 may form a LAN 108 within a hospice care unit within the same hospital. While a grid 104 may form a LAN 108, grids 104 may be interconnected across LANs 108 or areas of the hospital.

Grid segments 104 comprise a plurality of communication device nodes 106, also referred to as nodes 106. The nodes 106 comprise both the client and the server functions of the present invention. In other words, every node 106 comprises both some server functions and some client functions. Each node 106 can connect with one or more medical devices. The medical devices supply medical information to the nodes 106, and the nodes 106 can control the medical devices. Thus, regardless of the node's position in the grid 104, the node 106 can supply a network connection to any medical device. It is important to note that the nodes 106 are communicatively independent from the medical devices. While some medical devices may physically incorporate a node 106, for example, a node attached to a mobile infusion pump, the nodes 106 may still function to provide networking to other nodes 106 or other medical devices.

The entire network 102, including each separate grid 104, can connect to one, and sometimes more than one, Hospital Information System (HIS) Server 110. The HIS Server 110 is a system that requests, receives, and stores medical information. The HIS Server 110 may include or be connected to a medical information database 112. As medical information becomes available at a node 106, from a medical device attached to that node 106, the node 106 can send that information to the HIS Server 110 for storage and archiving. The HIS Server 110 does not provide monitoring or management functions to the grids 104. However, the HIS Server 110 can create information routines, for example recurring requests for certain information from certain medical devices attached to certain nodes 106, that can instruct a node 106 to respond with medical information.

In other embodiments, the network 102 may connect to a grid management software module 109. This grid management software module 109, often referred to as GridView™ Program, allows network administrators access to and monitoring of the network 102. The GridView™ Program 109 may maintain a configuration and status representation of each grid 104 for the user. This representation can show the user what nodes 106 are connected, how those nodes 106 are configured, what medical devices 216 are connected to each node 106, and other information. The user can manually change characteristics of the grid 104 using GridView™ Program 109. A further description of GridView™ Program 109 is supplied later in this document.

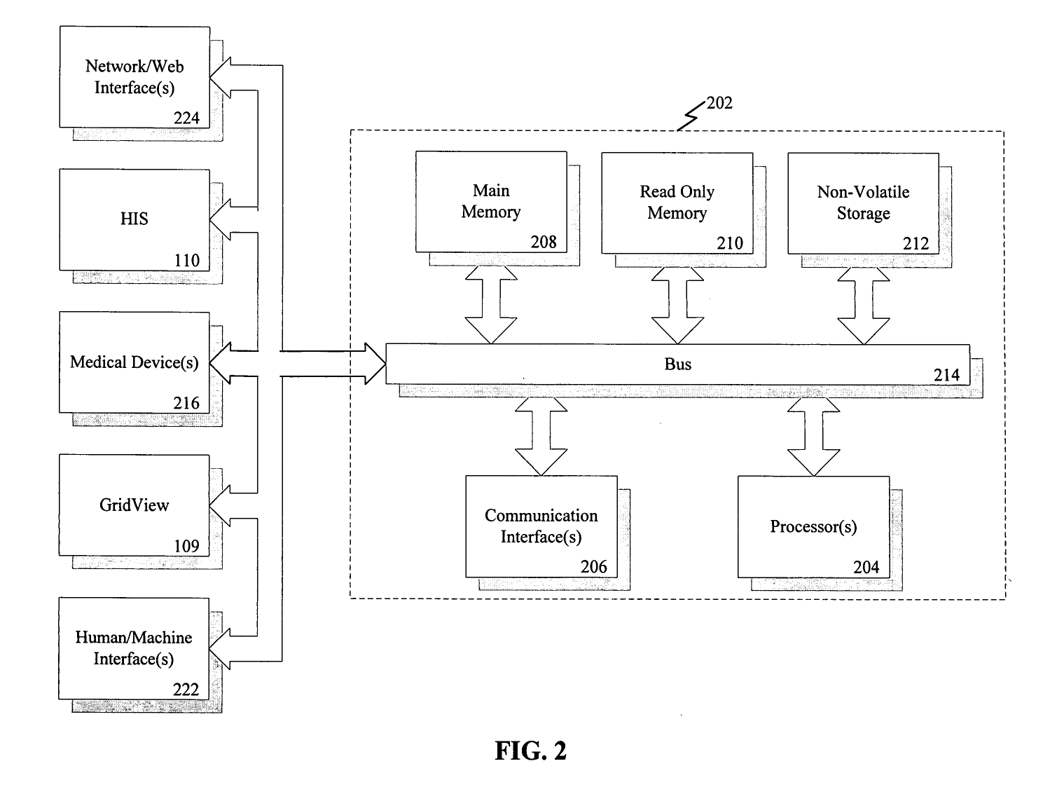

FIG. 2 illustrates an exemplary computing device 202, for implementing the invention. The computing device or computer system 202 can represent the communication node devices 106 and other possible computing devices, in which various features of the present invention may be implemented. In its most basic configuration, the computing system 202 comprises a bus 214 or other communication means for communicating data and control information, and one or more microprocessors 204, such as an ARM® 16/32-bit embedded RISC microprocessor, Intel® XScale™ processor, or Intel® Pentium®, Xeon™, or Celeron® processors, coupled with the bus 214.

Computer system 202 further comprises one or more memories 208, 210, or 212, such as the random access memory (RAM) or other dynamic storage device (referred to as main memory 208), coupled to the bus 214 for storing information and instructions to be executed by the processor 204. Main memory 208 also may be for storing temporary variables or other intermediate information during execution of instructions by the processor 204.

Computer system 202 also comprises a read only memory 210 and/or static storage device coupled to the bus 214 for storing static information and instructions for main memory 208. Non-volatile (NV) storage 212, such as NVRAM, may also be coupled to the bus 214 for storing information when the computer system 202 is turned off or otherwise loses its external power source.

One or more communication interface(s) 206 may also be coupled to the bus 214 for supporting wired and/or wireless communications to/from the computer system 202. The communication interface(s) 206 may include one or more integrated wireless interfaces for supporting wireless communication, such as IEEE 802.11b interfaces and/or Bluetooth™ wireless technology interfaces. Software and/or firmware associated with the communication interface(s) 206 may implement widely used and understood transport protocols, including, but not limited to, (1) standard socket interfaces utilizing TCP/IP protocol with custom port numbers; (2) Point-To-Point connections in the case of Bluetooth™; (3) Web interface mechanisms using TCP/IP port 80 and HyperText Transfer Protocol (HTTP); (4) extensible Markup Language (XML) messaging using any TCP/IP port (including port 80); (5) File Transfer Protocol (FTP) using TCP/IP port 21; and/or (6) Telnet sessions using TCP/IP port 23. The use of custom TCP/IP socket interfaces may be driven by individual medical device 216 vendors who with to implement a more secure connection environment.

The communication interface(s) 206 may also include various combinations of well-known, standard transport mediums, such as serial ports (e.g., RS-232 using a Universal Asynchronous Receiver/Transmitter (UART) or other device(s), universal serial bus (USB) 214, IEEE-1394 bus (“Firewire”) 214, parallel posts, Ethernet (IEEE 802.3) ports, and or other well-known communication and network interfaces 206. In any event, the computer system 202 may be coupled to a Local Area Network (LAN) 224 or Wireless Local Area Network (WLAN) 224 for connection to a HIS server 110 and database 112, to peripherals, such as data recorders, charting devices, and monitors, and/or to the GridView™ Program 109 that allows network administrators to intervene into the grid segments 104. The communication interface(s) 206 may also include a connection to a web server application 224 that can transfer information to a web browser or external application. A web server interface 224 may include a Common Gateway Interface (CGI) software application that provides the information to the web server 224.

Communications interface(s) 206 also embodies communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media.

Computer system 202 may also be coupled via the bus 214 to a human machine interface(s) 222, including controls, alarm indicators, and display devices (e.g. cathode ray tubes (CRT), plasma screens, or Liquid Crystal Display (LCD)) for displaying information to and/or receiving input from a care provider. For example, raw data, such as Electrocardiogram (ECG) or Electroencephalogram (EEG) signals, or data from analyses of heart rate and blood pressure may be provided via the human/machine interface(s) 222.

Human machine interface(s) 222 may also include input device(s), such as keyboards, mouse, pens, voice input devices, touch input devices, etc. Output device(s) 222, such as displays, speakers, printers, etc. may also be included. All these devices are well known in the art and need not be discussed at length here.

In the context of medical devices 216, typically one or more medical devices or sensors 216, such as electrodes or probes, are also coupled to the bus 214 for receiving physiological signals from a patient and providing the information to the processor 204.

Computing system 202 typically includes at least some form of computer readable media. Computer readable media can be any available media that can be accessed by processing unit 204. By way of example, and not limitation, computer readable media may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by processing unit 204. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer readable media. The term computer readable media as used herein includes both storage media and communication media.

The HIS system 110 can require certain communication interface(s) 206. The HIS 110 may use a health care information standard, like Health Level 7, for communications. Thus, the communication interface(s) 206 may receive or transmit medical information in one of these health care information standards. In addition, the transfer of information may use XML or other protocol. Also, due to security reasons, any transfer of information that may be sensitive could require certain security measures, such as the use of a Secure Socket Layer (SSL) protocol or encryption, such as 128-bit Wired Equivalent Privacy (WEP) protocol.

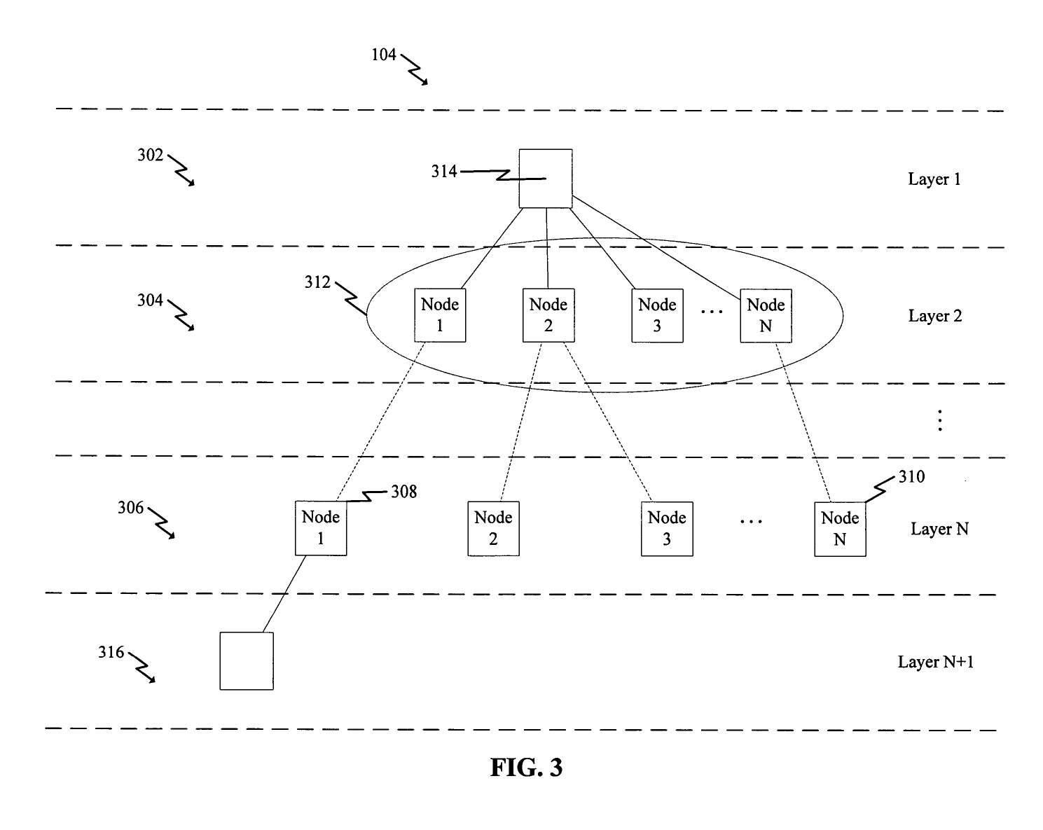

FIG. 3 provides an exemplary and simplified grid segment 104. A grid segment 104 may form a tree-type architecture with several parent/child relationships. For instance, node 314 is a parent to all nodes in the group 312. A parent node may have any number of children nodes, as represented by the N number of nodes in the group 312. Each child node has one parent node. These parent/child relationships are created when the child node first connects to the grid 104. The child node sends a message to all nodes 106 in the grid 104 requesting a connection to the grid 104. Any connected node 106 can respond to the requesting node. The requesting node determines which connected node 106 with which to connect and completes a connection with that node 106. After the connection, the new node 106 becomes the child node of that node 106 to which it connected. The newly connected node 106 can then respond to any requesting node allowing the next requesting node to become a child.

A set of children can form a layer, also referred to as a tier, within the grid 104. A layer is the set of nodes 106 a certain number of levels, in the hierarchy, from the first or top node 314. A grid 104 may have any number of layers. In FIG. 3, there exists Layer 1 302, Layer 1 304, up to Layer N 306 and Layer N+1 316. Each layer may have an unlimited number of nodes 106 as seen in Layer N 306 wherein Node 1 308 through Node N 310 are all in Layer N 306. The layers or tiers may also be incremented from the bottom to the top. Thus, the top layer 302 can have the top node 314 or, in other words, the top node 314 is always in the highest layer. A node 106 in a layer may share a parent with any other node 106 in that layer. However, in most layers, a portion of the nodes 106 in the layer will have a different parent than another portion of the nodes 106 in that layer. In general, the tree-type architecture creates an organization of children, parents, grandparents, and so on. The grid 104 can continue to expand to add further nodes 106 in any layer and to add further layers.

In exemplary embodiments, the tree-type architecture has a balanced tree. In other words, new nodes 106 are added such that each branch of the grid 104 has a substantially similar structure to the other branches. This similarity requires that no single branch becomes inordinately longer, more populated with nodes 106, or more complex than the other branch. Thus, as an unconnected node tries to connect to a grid 104, the nodes 106 can evaluate the best place for the new node to connect. Only those nodes 106 that are more appropriate parents may respond to the connection request. For example, if a first branch has two layers with three nodes in each layer while a second branch has two layers but the bottom layer has only two nodes, only the node in the bottom layer of the second branch may respond to a connect request. In other embodiments, the grid may continue to add nodes to existing layers of the branches before starting a new layer. One skilled in the art will recognize other methods of keeping the branches substantially similar. The methods of determining which node 106 should respond to connection requests will be explained in more detail below.

A connection of a node 106 to the grid 104 may be a wired connection, such as an Ethernet connection, or a wireless connection, using an 802.11b, Bluetooth™, or other communication method or system. Thus, the node 106 may be communicatively connected to the network 102 by a wired connection. In other embodiments, the node 106 may be physically attached to or incorporated in a medical device 216. These nodes 106 can form mobile nodes 106 that can connect to the grid 104 using wireless technologies. These mobile nodes 106 can still function in the same manner as any other node 106 in the grid 104. Thus, the mobile nodes 106 can have children, grandchildren, and the like. The process of a node 106 connecting to the grid 104 will be explained in more detail below.

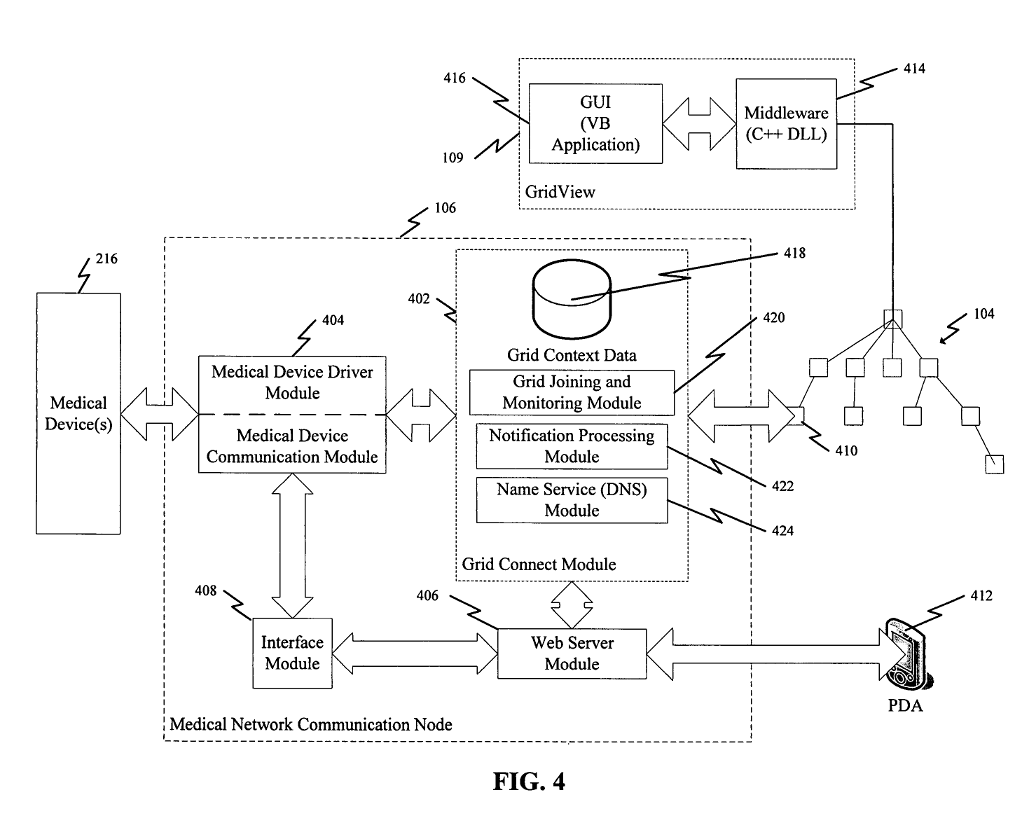

Referring to FIG. 4, an exemplary node 106 is provided in accordance with the present invention. The node 106 may include, but is not limited to, a grid connect module 402, a medical device driver and communication module 404, a web server module 406, and an interface module 408. The grid connect module 402 may include, but is not limited to, a grid joining and monitoring module 420, a name service (DNS) module 424, a notification processing module 422, and a grid context data 418. The grid joining and monitoring module 420 can include all functions for establishing a connection to the grid 104, communicating with the grid 104, monitoring the grid 104, and connecting with children. In the embodiment shown, the grid joining and monitoring module 420 has established a communicative link or coupled to a node 410 in the grid 104. This connection can be either a wired connection or a wireless connection. The grid joining and monitoring module 420 can send out the broadcast message to the connected nodes 106 in grid 104 and receive one or more authorizations to connect to one or more nodes 106. After determining which node 410 with which to connect, the grid joining and monitoring module 420 can complete the coupling, including any handshaking or other requirements. The functionality of the grid joining and monitoring module 420 module will be described more completely below with reference to the methods of connecting and monitoring.

In a hub-and-spoke architecture, the server would contain the name service function. The present invention includes a name service module 424 in every node 106. Thus, when a name service request arrives, any node 106 may respond with an IP address for the requested name. In one embodiment, a device, such as a PDA 412, that desires name service broadcasts a name service request. This broadcast could be a User Datagram Protocol (UDP) broadcast to every connected node 106 in the grid 104. Any connected node 106 could reply to the broadcast, or an algorithm governing which node 106 would reply could be followed. The latter type of reply process would limit the number of replies that the PDA 412 would receive. The grid name service function could emulate Domain Name Server (DNS), Dynamic Domain Name Server (DDNS), or other name service function.

In some further embodiments, a node device 106 may desire to connect across or to another LAN 108. This situation may occur when a mobile medical device 216 is transferred from one hospital area to another. In that situation, the mobile medical device 216 may have already received name service, and thus, it has an IP address. Then, after moving to a new area of the hospital, the device 216 may desire to be connected to a grid 104, but not the same grid that the device 216 was originally connected. The node 106 may then seek name service from the new grid 104. The grid 104 may contact a separate device or node that can communicate between all the grids 104 in the network 102, but which is not a part of any grid segment 104. This request may be a TCP/IP request to the separate node. This separate node may query all grids 104 to ask for the IP address for this connecting node 106. In other embodiments, the separate device may supply name service for connecting nodes 106 in these situations. Thus, the separate node can receive or retrieve all IP address and domain name information from all grids 104 in the network 102. The IP address is supplied to the grid 104 that made the request, and the connecting node 106 is allowed to connect.

The present invention can also include a notification processing module 422. The notification processing module 422 functions to respond to notices sent from the GridView™ Program 109. The notices can require the node 106 to make some change or adjustment to its configuration or status. The notification processing module 422 can receive the notification, determine if the node 106 can respond to the notification at that time, and complete any requirements necessary to respond to the notification. More description on the notification processing module 422 is presented below with reference to the method of changing the grid status with GridView™ Program 109.

To monitor the grid 104 status, each node 106 stores a copy of the grid context data 418. Grid context data 418 includes information on the configuration and status of each node 106 in the grid 104. The configuration information may include, but is not limited to, information on children attached to the node 106, medical devices 216 attached to the node 106, software and the software version on the node 106, current layer of the node 106, the node's parent, what the node 106 is currently doing. Status information may include, but is not limited to, information regarding whether the node 106 is online, what communications the node 106 is currently handling, the process the node 106 is currently handling, and the current tasks assigned to the node 106. Each node 106 may store the grid context data 418 in any form or format. Once a change to the grid context data 418 occurs, any node 106 recognizing or becoming aware of a change in the grid 104 can distribute the updated grid context data 418. Other nodes 106 can relay the information until the entire grid 104 has the updated grid context data 418. The process of monitoring the grid 104 using the grid context data 418 is described more fully hereinafter.

In addition to connecting to devices at the node 106, the grid connect module 402 may also interface with the HIS Server 110. The interface may be a transfer of data using XML or HL7 to the HIS 110. Thus, all information generated from medical devices 216 connected to the node 106 can be transferred to the HIS system 110. In addition, any information generated from medical devices 216 connected to the node 106 can be sent to any other node 106 in the grid 104.

A medical device 216 driver and communication module 404 is also included in the node 106. This module 404 couples with and forms connections with various medical devices 216. Many medical devices 216 include an RS232 interface, a USB interface, or other type interface. The medical communication module 404 may translate messages to and from these devices 216 into or from any protocol, form, or syntax. In other embodiments, the communications module 404 may forward the received data to another module for translation. The medical communications module 404 may connect to any medical device 216 using any appropriate protocol or connection, including USB, wireless (802.11b or Bluetooth), serial, analog, parallel, or the like.

The medical device driver module 404 stores, in a memory, device drivers for a plurality of medical devices 216. When the node 106 is directed to connect to a medical device 216, the user may direct the device driver module 404 to use a certain device driver. In other embodiments, the module 404 may automatically determine the driver to use, by evaluating the device 216 with which the user desires to connect. Regardless, the device driver module 404 can load the appropriate driver and utilize that driver to communicate with the medical device 216.

The node 106 may also include a web server module 406. The web server module 406 can handle communications and interfaces with external computing devices, such as PDAs, laptops computers, and the like, that seek information from the medical devices 216. The web server module 406 provides an interface with a web browser. The interface can include a Common Gateway Interface (CGI) for transferring information from the medical devices 216 to an external device 412 connecting through the web server 406. In addition, the web server 406 may also include 802.1×gateway authentication with 128 bit WEP support. In the embodiment shown, the web server 406 may interface with a PDA 412. A doctor may desire information from a medical device 216 connected to the node 106. The PDA 412 may wirelessly connect with the node 106. The node 106 can complete all connection requirements for the web browser. The PDA 412 may then request information from a medical device 216. A message in the web server module 406 can instruct the communications module 404 to obtain or forward that information. Using XML or custom workflows, the web server module 406 can transmit that information to the PDA 412. A locally connected device can also access the HIS information through the web server 406. The grid connect module 104 can receive information from the HIS 110 and forward it to the web server 406 for transmission to the connected device 412.

In other embodiments, the caregiver can receive information from a different node 106 in the grid. The user may request data from a medical device 216. The node 106 may ask another node 106 to respond to the request. This request to respond may be sent to one node 106 that was identified from the grid context data 418 or may be broadcast to allow any node 106 to respond. The other node 106 can send the requested data either to the node 106 that received the request to forward the information to the user or can send the request directly to the user, if possible. Regardless, the information is relayed to the requesting caregiver.

An interface module 408 may also be included in the node 106. If translation services between the medical device communications module 404 and the web server 406, or grid connect module 402, are required, the interface module 408 may accomplish any required translations. The interface module 408 can take the received information from the medical devices 216 and compose it into a usable format for connected devices interfacing with the web server module 406 or for the HIS 110 or other device. In addition, the interface module 408 may translate information requests from the web server module 406 or grid connect module 402 into machine understandable formats for the medical devices 216.

FIG. 4 also provides an embodiment of the GridView™ Program 109. In this embodiment, the GridView™ Program 109 includes a middleware module 414 and a user interface 416. The middleware module 414 comprises a translation and information retrieval engine. Grid context data from the nodes 106 is sent to the middleware module 414. The middleware 414 recomposes the information into an understandable format for the user interface 416. In addition, the middleware 414 transforms directives from the user into understandable commands and directives for the nodes 106. Thus, any information transmission between the GridView™ Program 109 and the nodes 106 is controlled by the middleware 414. The middleware 414 can also include any libraries, such as dynamic link libraries and the like, used in the GridView™ Program 109.

The user interface 416 can provide or present the grid context data 418 to the user or network administrator. The presentation, in one embodiment, is in a tree-like file directory. The user can perceive what grids 104 are on the network 102, what nodes 106 are in the grids 104, and the status and configuration of all the nodes 106. In an exemplary embodiment, the user interface 416 is a graphical user interface (GUI). The user interface 416 can also receive user directives that are sent to the middleware 414. In one embodiment, the user interface 416 is a Visual Basic® coded application.

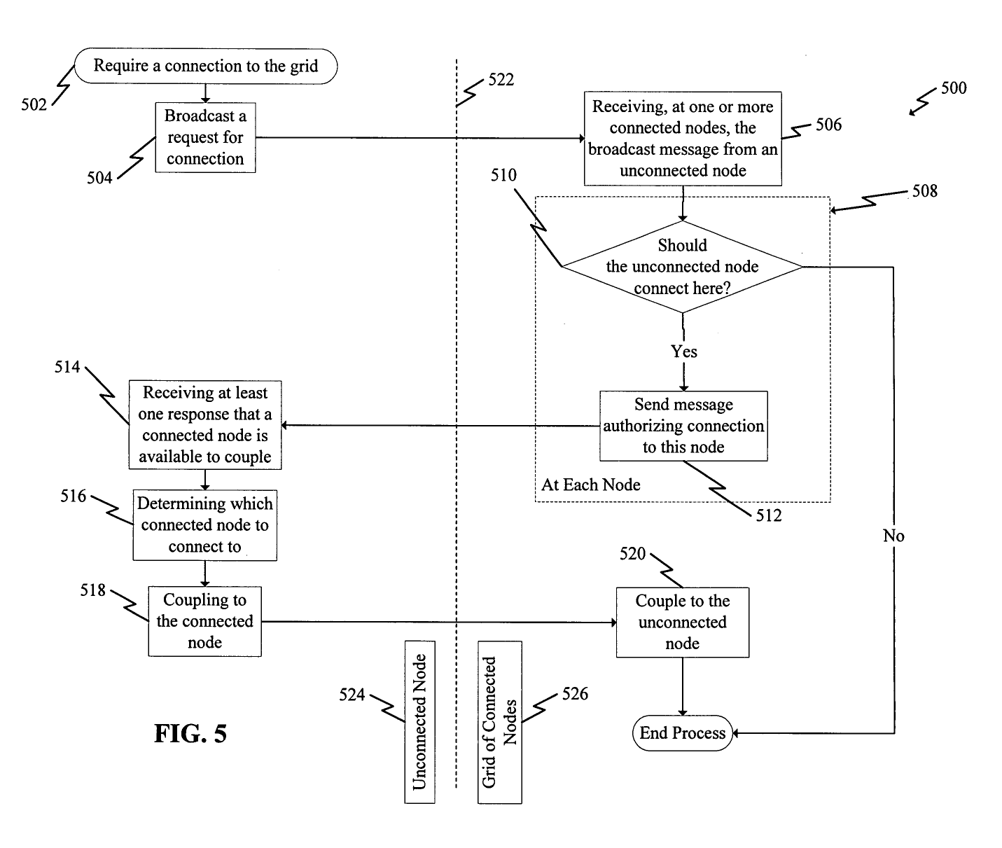

Referring to FIG. 5, an embodiment of a method 500 to connect an unconnected node to the grid 104 is shown. The flow diagram shows process steps both for the unconnected node and the node(s) 106 already connected to the grid 104. The demarcation line 522 splits the tasks for the unconnected node as delineated by label 524 from the tasks for the node(s) 106 connected to the grid 104 as delineated by label 526. The process begins with block 502 when an unconnected communication node device 106 requires a connection to a grid 104. As one skilled in the art will recognize, the need to connect to the grid 104 may arise from numerous situations. For instance, the node 106 may have gone offline and come back online but was disconnected in the process. In exemplary embodiments, a node 106 physically attached to a medical device 216 may come online when the medical device 216 is activated. The node 106 may need to connect to the grid 104 via a wireless connection to provide information to the HIS 110 through the grid 104. In another exemplary embodiment, the node 106 may be activated when a patient first enters a hospital and fills a bed. The equipment 216 used with that bed might be activated. The node 106 communicatively attached to the suite of medical devices 216 may then need a connection to the grid 104.

At block 504, once the node 106 requires a connection to the grid 104, the node 106 sends a message requesting a connection. For the wireless node 106 described above, the request message may be broadcast or multicast. The broadcast or multicast may be to a predefined multicast address with a request, using one or more IP datagrams, regarding an available parent node 106. The broadcast may be a User Datagram Protocol (UDP) broadcast to all nodes 106 requesting a node 106 with which to connect. The request may also include a request for name service from the DNS or DDNS module in a node 106 or to a separate device providing name service across LANs 108.

At block 506, one or more connected nodes 106 receive the request for connection by the unconnected node. Then, each node 106 in the grid 104, as shown by box 508, accomplishes a set of tasks. At block 510, each node 106 determines if the unconnected node should connect to that node 106. This determination requires each node 106 to review the grid context data 418 stored at the node 106. The node 106 can apply one or more rules to the grid context data 418. In an exemplary embodiment, the node 106 determines whether connecting to that node 106 would maintain a “balanced” or “well-pruned” tree-type architecture. The node 106 may assess the number of children, grandchildren, and great-grandchildren in its branch of the grid 104. If the node 106 has too many nodes 106 within its branch compared to other branches, that node 106 may not reply to the connect request message. In another exemplary embodiment, if the unconnected node is a wireless node 106, nodes 106 that can directly receive the wireless signals may respond to the connect request. Thus, only nodes 106 not receiving the wireless signal but available to connect will decline to respond to the connect request message. One skilled in the art will recognize other logical determinations for which node 106 will respond to the connect request. If the node 106 determines that it should connect with the unconnected node, the node 106 sends a message, at block 512, to the unconnected node authorizing a connection at that node 106. The connect message can also supply the IP address and domain name to the node 106.

At block 514, the unconnected node receives one or more connection authorization messages. The unconnected node determines, at block 516, which node 106 with which to connect. In an exemplary embodiment, whichever connect message arrives first at the unconnected node, the unconnected nodes 106 couples with that node 106 that sent the first message. In other embodiments, the unconnected node may receive grid context data 418 and review the data. The unconnected node may make its own assessment of where to connect.

Regardless, once determined, the unconnected node begins the connection or coupling process with the selected node 106, at block 518. The connected node 106, at block 520, also begins the connection process with the unconnected node. Grid context data 418 may be supplied to the newly connected node 106. Any handshaking and IP address functions are completed, and the process 500 ends.

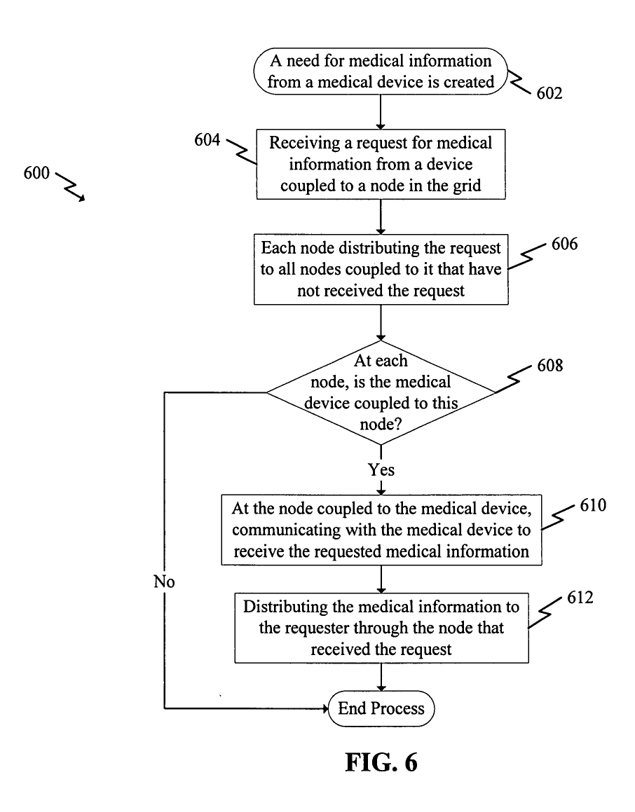

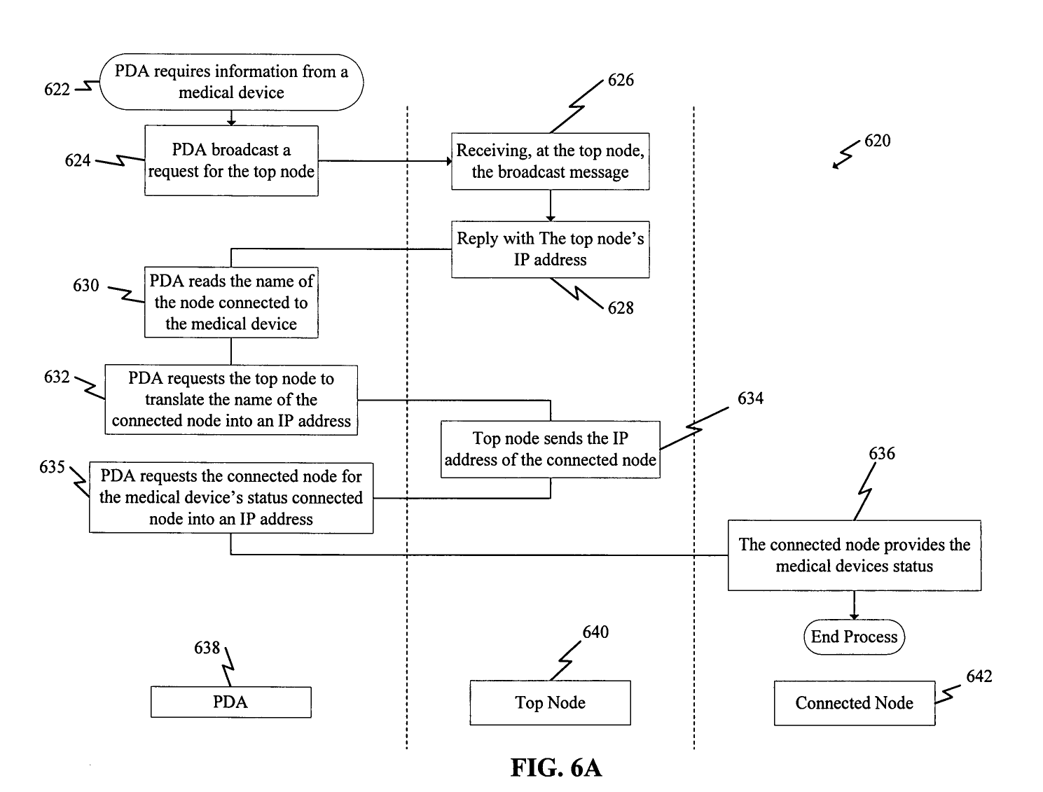

Referring to FIG. 6, a process 600 for providing medical information to a requestor is illustrated. The process begins, at block 602, when a need for medical information is created. A need for medical information may occur when a PDA 412 or handheld device is connected to the web server 406 of the node 106. The PDA 412 sends a request to the node 106 for certain medical information. In other embodiments, a HIS 110 system may request information from a medical device 216 attached to the node 106. The HIS 110 request may be recurring. Thus, the HIS 110 may establish a routine, with the node 106, to send periodically medical information from a certain medical device 216 or from all medical devices 216 attached to the node 106. In other embodiments, the HIS 110 may require all information about a patient be sent to the HIS 110. The node 106 or the HIS 110 may resolve which medical devices 216 from which to obtain the medical information and consistently send that information to the HIS 110. The requests may also establish a flow-through of data. In other words, the information produced by the medical device 216 is sent to the requester whenever the node 106 receives the information from the medical device 216. Some embodiments may have the node 106 functioning as a cache for the information—storing medical information and bursting the information to a requester.

At block 604, whatever the need, a node 106 receives a request for medical information produced by a medical device 216. This message may specify a node 106 where the medical device 216 is connected. However, in some embodiments, the message only gives a name or MAC address for the medical device 216. In other words, the requester knows which medical device 216 the information must come from, but the requester does not know which node 106 that medical device 216 is connected to. Thus, the received message at the node 106 must be forwarded or disseminated to all other nodes 106 in the grid 104.

At block 606, each node 106 determines if its children or parent has received the request message. In some embodiments, the node 106 determines where the message came from, either a parent or child, and relays the message to all other nodes 106 connected to it that it did not receive the message from. In this manner, all nodes 106 will receive the message. In another embodiment, the first node 106 that receives the message may determine, from the grid context data 418, which node 106 has that particular medical device 216 attached to it. The first node 106 sends the message directly to that node 106 for a response.

Each node 106 then analyzes, at block 608, its information on the medical devices 216 connected at that node 106. The nodes 106 determine if the medical device 216 that information is requested from is connected at that node 106. If the medical device 216 is not connected to that node 106, the node 106 can ignore the message. If the medical device 216 is connected to that node 106, the process moves to block 610, and the node 106 establishes communications, if needed, with the medical device or devices 216. The node 106 receives information from those medical devices 216. In other embodiments, the node 106 may have stored the needed medical information and retrieves the information from memory. Regardless, the information is compiled in total or a portion of the information is compiled. This set of information is then distributed, at block 612, to the node 106 that received the request.

Thus, if a PDA 412 or handheld device asked for the information, the node 106 connected to that PDA 412 would receive the set of information. The node 106 connected to the PDA 412 can then relay the information to the connected handheld device. In other embodiments, the node 106 that compiled the information may send the information directly to the requester without going through the node 106 that received the request. This situation may occur when the HIS 110 makes the request. The node 106 with the compiled data may send it directly to the HIS 110 without involving the node 106 that received the request. Once the information is distributed, the process ends.

An example of this process occurs when a caregiver wants to check an order for patient care against the actual delivery of that care. In this example, a caregiver enters a patient's room. The caregiver decides to check his order for delivery of a medication, such as morphine. Using his PDA 412, the caregiver requests the Human Capital, Innovation Technology (HCIT) form detailing the order for medication delivery. The request is received via an infrared link 206 to the web server 406 at a node 106. The node 106 queries the HIS 110 for this information. The HIS 110 retrieves the information from the HIS database 112 and send the information back to the node 106. The node 106 formats the information for display on a web page driven by the web server 406. The caregiver receives the web page, again through the infrared link 206, with the HCIT form displayed.

Now, the caregiver desires to check this order against what medication is actually being given to the patient. Again, the caregiver through the infrared link 206 on the PDA 412 requests a web page showing how a particular infusion pump 216 is dispensing medication to the particular patient. The node 106 receives the request and begins a CGI script. The CGI script directs the medical communication module 404 to upload a driver for the infusion pump 216 and retrieve information for that infusion pump 216. Through the RS-232 UART 206, the node 106 connects with the infusion pump 216 and directs the pump 216 to send information to the node 106. The node 106 decodes the incoming data. At the interface module 408, the node 106 reformats the received data from the pump 216 and transforms it into a usable format for the caregiver. The web server 406 puts the information into a web page and delivers it, through the infrared link 206, to the caregiver's PDA 412. At this point, the caregiver now can view both the HCIT form and the actual telemetry or data from the infusion pump 216. With a quick comparison, the caregiver can determine that the medical order is being fulfilled correctly.

A further embodiment of a process 620 of providing medical information to a requester is provided in FIG. 6A. In this embodiment, the external requester is a PDA 412. Three different elements are involved in the method 620, the PDA 412, the top node 318, and a connected node 106. The steps performed by each element is broken out and set into three different area denoted by the label 638 for the PDA 412, the label 640 for the top node 314, and the label 642 for the connected node 106.

The process 620 begins at block 622 when a PDA 412 desires information from a medical device 216 connected to the connected node 106. The PDA 412 sends a broadcast message for the top node 318, as shown in block 624. This broadcast message can be the same or similar to the broadcast message explained above. A wireless connection point may receive the broadcast and place the message on the grid 104 for the top node 318.

The top node 318 receives the broadcast message at block 626. In response, the top node 318 sends its IP address to the PDA 412, as seen in block 628. At this point, the top node 318 and the PDA 412 may communicate, either through a TCP/IP connection or other protocol. Referring to block 630, the PDA 412 the reads the name of the node 106 connected to the medical device 216 from which the PDA 412 desires the medical information. In one embodiment, the PDA 412 scans a barcode that represents the name of the node 106. In other embodiments, the caregiver may type the name of the node into the PDA 412 and send that name to the top node 318.

Referring to block 632, the PDA 412 sends, to the top node 318, the name with a request for and IP address for the connected node 106. Again, this message may be sent through a wireless access point to the top node 318. The top node 318 can determine the IP address from the name by checking the grid context data 418. The top node 318 can then send the IP address of the connected node 106 to the PDA 412, as shown in block 634.

At block 635, the PDA 412 can receive the IP address. With the IP address, the PDA 412 can request status from the medical device 216 connected to the node 106, as shown in block 635. This connection can be a TCP/IP communication or other point-to-point type communication. Status information from the medial device 216 can include any information produced by the medical device 216. Thus, the PDA 412 can receive medical information about a patient using this request. At block 636, the connected node 106 can receive the data from the medical device 216 and relay it to the PDA 412.

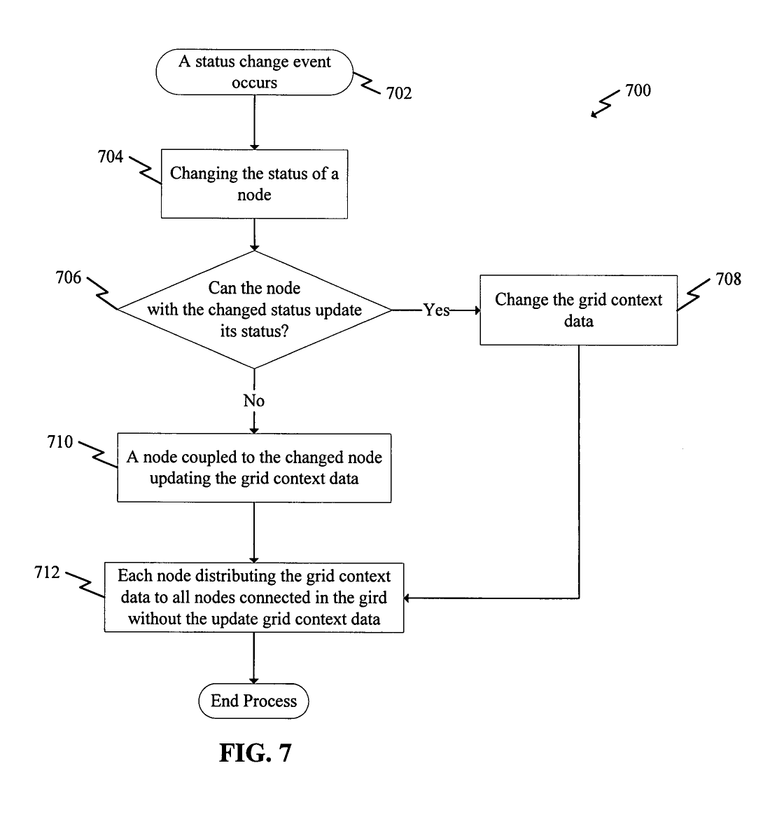

FIG. 7 illustrates an embodiment of a method 700 for self-monitoring the grid 104. While monitoring is constantly occurring at every node 106 in the grid 104, the following embodiment will highlight what occurs when the grid 104 changes. Thus, the process begins, at block 702, when a change in the status of the grid 104 occurs. The change of status may be a node 106 that goes offline or is disconnected. A new medical device 216 might be attached to a node 106. A node 106 may acquire a new child. One skilled in the art will recognize other events that may precipitate a change in the grid 104. Whatever the event, a change in the status or configuration of a node 106 occurs at block 704.

Referring to block 706, it is then determined whether the changed node 106 can record the change to its own status. At least one node 106 completes the determination, whether it is the changed node 106 that is still on the grid 104 or those nodes 106 directly coupled to the changed node 106 (i.e. the children and parent nodes 106). For instance, if a node 106 goes offline, it cannot update its own status. Therefore, a parent node 106 must change the grid context data 418 as shown at block 710. However, if the node 106 has added a child node 106 or a medical device 216, that node 106 can update its own grid context data 418, at block 708.

At block 712, the node 106 that updates the grid context data 418 starts the dissemination process. Each node 106 distributes the changed grid context data 418 to all nodes 106, attached to that node 106, that have not received the changed data 418. Like the dissemination process described above, each node 106 can determine where the data 418 came from and send the data 418 to the nodes 106 that did not send the data 418. Thus, the changed data 418 is spread throughout the grid 104. Thus, every node 106 is again monitoring the grid 104 with the most current grid context data 418.

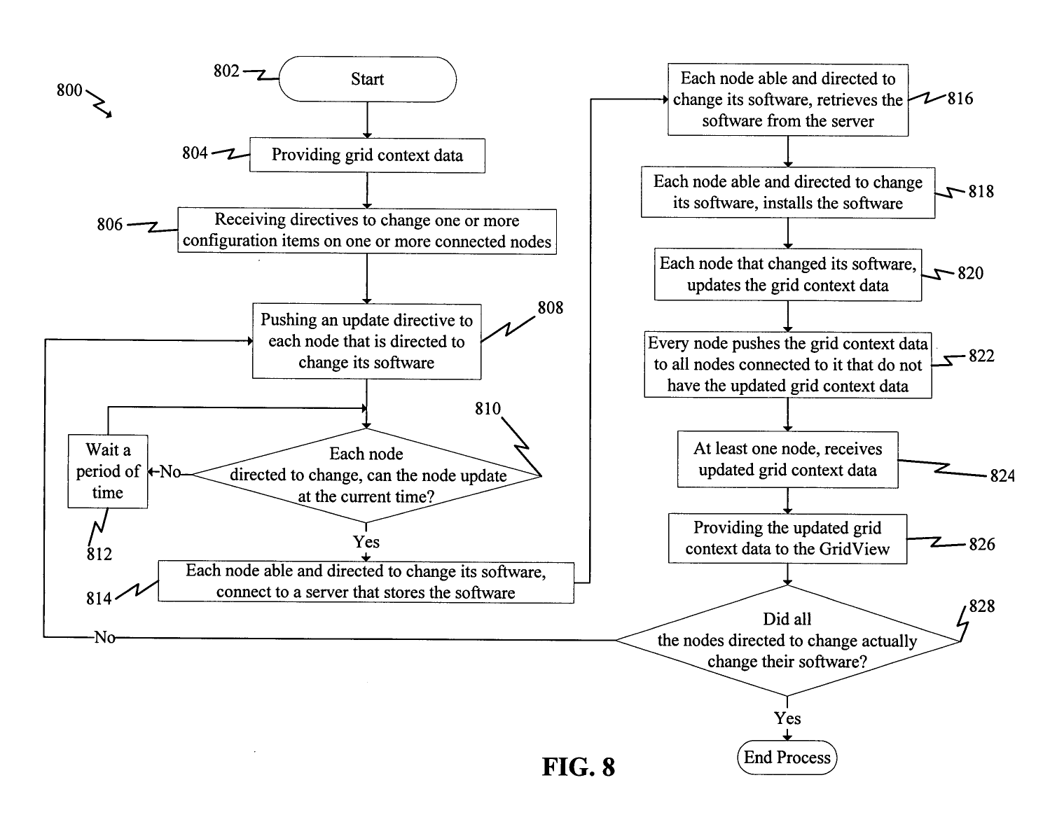

In accordance with an embodiment of the invention, FIG. 8 illustrates a method 800 of allowing a user or network administrator to update the grid 104. For this embodiment, the update involved will describe the forced update of software drivers on one or more nodes 106. It is important to note that this is not the only update or change a user can make. Rather, one skilled in the art will recognize different updates or changes that may be made using the GridView™ Program 109. The driver update embodiment is provided for explanatory purposes and not to limit the invention to that one embodiment.

The process starts, at block 802, when the user desires to change or update at least some portion of the grid 104. In some embodiments, the user initiates the GridView™ Program 109. The GridView™ Program 109 provides, at block 804, the user with the grid context data 418. Each grid 104 on the network 102 can send the grid context data 418 to the user's computing device. The GridView™ Program 109 application organizes the grid context data 418 into an easy to understand format for the user. The middleware module 414 in the GridView™ Program 109 retrieves the grid context data 418 and formats it for display in the user interface 416. In some embodiments, the grid context data 418 is displayed as a file tree.

At block 806, the user can decide to make one or more changes to a grid 104 based on the grid context data 418. The GridView™ Program 109 can provide an interface, such as the GUI 416, for the user to enter the desired changes. GridView™ Program 109 receives the directives to make a change to one or more configuration items on one or more nodes 106. In the embodiment provided, the directive is to change the driver software in one or more nodes 106. The GridView™ Program 109 application can then respond to the received directive.

At block 808, the GridView™ Program 109 software pushes the directive down to each node 106 that the user directed to change. The nodes 106 can retrieve software from a software database or storage (such as an HTTP transfer from a TAR archive) or reorganize the gird as directed. The GridView™ Program 109 does not need to actually make any changes. While this embodiment provides good functionality, it is not the only embodiment, and the GridView™ Program 109 may make manual changes to the nodes 106 in some embodiments.

Referring to block 810, each node 106 receiving a directive determines if it can update at the current time. This determination allows the node 106 to review current processing and judge whether updating would cause a current process to stop functioning. Also, the node 106 may not have enough resources to respond to the update directive at the current time. If the node 106 cannot update at the current time, the node 106, at block 812, may wait a period of time then determine later if the node 106 can update. In other embodiments, the node 106 may ignore or discard the update directive and allow the GridView™ Program 109 to check compliance and then send, at a later time, a new directive to the node 106. Every node 106 that is able to update may respond to the directive.

At block 814, each node 106 responding to the directive to update the driver software can connect to a server or memory device that stores the updated software drivers. In this embodiment, a separate TAR server, a special node, or a separate computing device attached to the network 202 can retrieve drivers from a storage media or from the Internet. The TAR server may also receive software updates from the user via user-directed installs onto the server. The nodes 106, using TCP/IP or other protocol, request the software from the TAR server.

The nodes 106 can, at block 816, receive the software from the TAR server. Using TCP/IP, FTP, or other protocol, the TAR server sends the updated software to the nodes 106 that made a request. The nodes 106 can receive the software over the grid network 102 and can cache it for installation. Again, the node 106 may check to ensure installation can proceed. For instance, changing drivers may interfere with a current connection with a medical device 216 that uses the driver that will be replaced.

At block 818, the nodes 106 install the new software. The software replaces the software drivers with the new drivers and can delete the old software. Any connections with medical devices 216 that were suspended while installation occurred may be resumed. The node 106 can then return to normal functions.

At block 820, after the software is installed, each node 106 may update its grid context data 418 to reflect the change in the software. These changes are stored in memory at the node 106. Each node 106 with changed grid context data 418 can then push the updated data, at block 822, to other nodes 106. This process is similar to the process of pushing the grid context data 418 described earlier. However, more than one node 106 may be pushing updated grid context data 418. Therefore, the determination of whether the node 106 has received the data 418 may become more complex. A node 106 may compare the pushed data 418 with currently existing grid context data 418. If a difference is determined, the node 106 may then accept the data 418 and update its stored grid context data file 418. A simpler method of determining which node 106 sent the data and pushing the data to other nodes 106 may not work if files are received at the same node 106 simultaneously. However, if the updated grid context data 418 is labeled or identified, then the simpler method described earlier may function properly, as one skilled in the art will understand.

At block 824, the received grid context data 418 is updated at each node 106 throughout the grid 104. Once the final grid context data 418 is stored, one or more nodes 106 may push the update a grid context data 418 to the GridView™ Program 109. The GridView™ Program 109 may receive and store the new data 418. GridView™ Program 109 may then provide, at block 826, the updated data 418 to the user. In some embodiments, the user may complete a verification, at block 828, that the nodes 106 directed to change software actually changed software. This verification may require the user to compare the current grid context data 418 with the old data and verify a change. In other embodiments, the verification may occur automatically in GridView™ Program 109.

If one or more nodes 106 failed to make the directed change, GridView™ Program 109 may send another message to the one or more nodes 106 that did not change. Then, the process of updating renews at block 808. If all nodes 106 updated, the process ends until the user makes more changes.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1) A network of devices for a medical information system, comprising:
one or more serverless grid segments, wherein each grid segment has a plurality of communication device nodes coupled together, wherein one or more of the communication device nodes are coupled to one or more medical devices, and wherein each communication device node is operable as both a client and a server.

2) A network according to claim 1, wherein at least two of the communication device nodes are coupled together in a child and parent relationship.

3) A network according to claim 2, wherein one node has a plurality of children.

4) A network according to claim 1, wherein one of the serverless grid segments has a tree-type architecture.

5) A network according to claim 4, wherein the tree-type architecture has one or more branches and is balanced such that each branch has a structure substantially similar as that of the other branches.

6) A network according to claim 1, wherein each node can supply domain name service to an unconnected node.

7) A network according to claim 1, wherein each node monitors the health and status of at least one other node.

8) A network according to claim 1, wherein at least one medical device is a mobile medical device.

9) A network according to claim 1, further comprising a hospital information system coupled to the network operable to communicate with any node in any grid segment.

10) A network according to claim 1, further comprising a grid management software module coupled to the network and operable to modify the configuration and monitor the status of any node in any grid segment.

11) A communication device node operable to form a grid segment in a medical information system network, the node comprising:
a grid connect module operable to couple into a medical information system network having one or more serverless grid segments; and
a medical device communication module coupled to the grid connect module operable to communicate with one or more medical devices.

12) A communication device node according to claim 11, wherein the grid connect module further comprises:
a grid joining and monitoring module;
a notification processing module;
a name service module; and
a memory having stored therein grid context data.

13) A communication device node according to claim 11, wherein the medical device communication module has a memory having stored therein one or more device drivers to interact with one or more medical devices.

14) A communication device node according to claim 11, further comprising a web server module coupled to the grid connect module providing an interface to external computing devices through a web browser.

15) A communication device node according to claim 14, further comprising an interface module coupled to the medical communication module and the web server module operable to translate information requests from external devices into an understandable format for the medical device communication module.

16) A method for coupling an unconnected node to a medical information system network having one or more serverless grid segments, comprising:
sending a request message from the unconnected node to one or more connected nodes in one or more of the grid segments requesting a connection;
receiving at least one response message from one or more of the connected nodes;
determining, from the response messages, a connected node with which to couple; and
coupling to the selected node in the grid segment.

17) A method according to claim 16, wherein sending the message comprises broadcasting the request message to a plurality of the connected nodes.

18) A method according to claim 17, wherein the message is a UDP broadcast message.

19) A method according to claim 16, wherein sending the request message comprises:
sending the request message, via a TCP/IP connection, to a computing device that can provide name service over a plurality of the grid segments; and
the computing device sending the request to a plurality of connected nodes on a plurality of grid segments.

20) A method according to claim 16, wherein the step of receiving comprises receiving an IP address and a domain name from one of the connected nodes in the one or more grid segment.

21) A method according to claim 20, further comprising:
the connected node supplying the IP address updating a grid context data to show the newly connected node;
pushing the updated grid context data to at least one other connected node; and
pushing the updated grid context data to the newly connected node.

22) A computer program product readable by a computer system and tangibly embodying a program of instructions executable by a computer system to perform the method of claim 16.

23) A method for coupling an unconnected node to a medical information system network having one or more serverless grid segments, comprising:
one or more of the connected nodes receiving from the unconnected requesting node the message requesting a connection;
each node receiving the request message determining if the requesting node should connect at that node;
all nodes that determine the requesting node may connect at that node, sending the response message to the requesting node; and
one connected node coupling with the requesting node, wherein the requesting node becomes a child of the connected node.

24) A computer program product readable by a computer system and tangibly embodying a program of instructions executable by a computer system to perform the method of claim 23.

25) A method for handling information from a medical information system network with one or more serverless grid segments, comprising:
receiving a request from an external device for medical information from a medical device coupled to a communication device node in one or the serverless grid segments;
distributing the request to at least one other communication device node;
each of the communication device nodes determining if the medical device is coupled to that communication device node;
if the device node is communicating with the medical device, that device node obtaining the requested medical information; and
distributing the medical information to the external device.

26) A method according to claim 25, wherein receiving a request from an external device further comprises coupling with the external device.

27) A method according to claim 26, wherein the external device couples with the communication device node through a web server on the communication device node.

28) A method according to claim 25, wherein distributing the request further comprises:
determining from grid context data which communication device node is coupled to the medical device; and
sending the request directly to the communication device node coupled to the medical device.

29) A method according to claim 25, wherein distributing further comprises:
sending the medical information back to the communication device node that received the request; and
relaying the medical information to the external device via the communication device node that received the request.

30) A computer program product readable by a computer system and tangibly embodying a program of instructions executable by a computer system to perform the method of claim 25.

31) A method for responding to a change in a self-monitored grid segment in a medical information system network, comprising:
changing a status of a communication device node;
updating grid context data reflecting the change in status of the communication device node; and
pushing that updated grid context data to at least one other communication device node.

32) A method according to claim 31, wherein the change in status is a configuration change.

33) A method according to claim 31, wherein updating the grid context data further comprises:
one or more communication device nodes connected to the changed node becoming aware of the change in status;
each connected node determining if the changed node can record the change in status; and
if the changed node cannot record the change in status, at least one connected node updating the grid context data.

34) A computer program product readable by a computer system and tangibly embodying a program of instructions executable by a computer system to perform the method of claim 31.

35) A method of intervening in a medical information system network having a serverless grid segment to change a status or configuration of a communication device node, comprising:
providing grid context data to a user;
receiving one or more directives to change one or more items on one or more communication device nodes in the network;
pushing an update directive to the one or more nodes;
each node determining if the node can update at the current time;
if the node can update, completing the change according to the one or more directives;
updating the grid context data;
pushing the updated grid context data to at least one other node; and
providing the updated grid context data to the user.

36) A method according to claim 35, wherein the grid context data and the updated grid context data are provided in a presentation on a graphical user interface.

37) A method according to claim 35, wherein the grid context data and the updated grid context data are provided in a grid management software module.

38) A method according to claim 35, wherein the directive to change one or more items is one of a directive to change a configuration of the node, directive to change a status of the node, or a directive to update a software module on the node.

39) A method according to claim 37, after receiving a directive to update a software module of the node, the method further comprising:
connecting with a software server;
requesting an updated or new software module from the software server according to the directive;
receiving the software module; and
installing the software module.

40) A computer program product readable by a computer system and tangibly embodying a program of instructions executable by a computer system to perform the method of claim 35.
